(19) United States
(12) Patent Application Publication
(10) Pub. No.: US 2026/0032430 A1
(43) Pub. Date: Jan. 29, 2026

(54) PRIVACY-ENHANCED RELATIVE LOCATION OF A VEHICLE

(71) Applicant: GM GLOBAL TECHNOLOGY OPERATIONS LLC, DETROIT, MI (US)

(72) Inventor: Mohamed A. Layouni, Fraser, MI (US)

(21) Appl. No.: 18/784,163

(22) Filed: Jul. 25, 2024

(51) Int. Cl. H04W 12/02; B60R 25/24; H04W 4/029; H04W 4/40

(52) U.S. Cl. CPC H04W 12/02; B60R 25/245; H04W 4/029; H04W 4/40

(57) ABSTRACT

Examples described herein provide a method for providing an imprecise location of a vehicle to a user device. The method includes receiving, at a processing system of the vehicle, a handshake request, the handshake request initiated by the user device associated with an operator of the vehicle. The method further includes determining, by the processing system of the vehicle, a precise location of the user device. The method further includes generating, by the processing system of the vehicle, the imprecise location of the vehicle. The method further includes transmitting the imprecise location of the vehicle from the processing system to the user device. The method further includes enabling a virtual key function of the user device based at least in part on the precise location of the user device and the imprecise location of the vehicle.

### BACKGROUND

The subject disclosure relates to vehicles, and in particular to providing a privacy-enhanced relative location of a vehicle.

Modern vehicles (e.g., a car, a motorcycle, a boat, or any other type of automobile) may be equipped with one or more communication systems for communicating with other vehicles and/or other devices. For example, a vehicle may be equipped with a communication system for communicating with another vehicle using vehicle-to-vehicle (V2V) communication. As another example, a vehicle may be equipped with a communication system for communicating with a user device, such as a smartphone, laptop computer, tablet computer, wearable computing device (e.g., smartwatch), and/or the like, including combinations and/or multiples thereof.

### SUMMARY

In one embodiment, a method for providing an imprecise location of a vehicle to a user device is provided. The method includes receiving, at a processing system of the vehicle, a handshake request, the handshake request initiated by the user device associated with an operator of the vehicle. The method further includes determining, by the processing system of the vehicle, a precise location of the user device. The method further includes generating, by the processing system of the vehicle, the imprecise location of the vehicle. The method further includes transmitting the imprecise location of the vehicle from the processing system to the user device. The method further includes enabling a virtual key function of the user device based at least in part on the precise location of the user device and the imprecise location of the vehicle.

In addition to one or more of the features described herein, or as an alternative, further embodiments of the method may include that generating the imprecise location of the vehicle includes applying a noise factor.

In addition to one or more of the features described herein, or as an alternative, further embodiments of the method may include that generating the imprecise location of the vehicle includes determining a T_{reply1} value, a T_{round1} value, a T_{round2} value, and a T_{reply2} value, applying the noise factor to each of the T_{reply1} value and the T_{round2} value, and calculating the imprecise location of the vehicle based at least in part on the noise factor applied to each of the T_{reply1} value and the T_{round2} value.

In addition to one or more of the features described herein, or as an alternative, further embodiments of the method may include that applying the noise factor to each of the T_{reply1} value and the T_{round2} value includes subtracting the noise factor from the T_{reply1} value and adding the noise factor to the T_{round2} value.

In addition to one or more of the features described herein, or as an alternative, further embodiments of the method may include that generating the imprecise location of the vehicle includes applying the noise factor to the T_{reply1} value and transmitting a resulting noisy T_{reply1} value to the user device, wherein the user device applies the noisy T_{reply1} value to compute an approximate distance to the vehicle.

In addition to one or more of the features described herein, or as an alternative, further embodiments of the method may include that generating the imprecise location of the vehicle is based at least in part on a time-difference-of-arrival (TDoA) or a phase-difference-of-arrival (PDoA) relative to a plurality of antennae of the vehicle and noise added to results of at least one of the TDoA or PDoA.

In addition to one or more of the features described herein, or as an alternative, further embodiments of the method may include that generating the imprecise location of the vehicle includes generating noisy information about geometric arrangement of a plurality of antennae of the vehicle.

In addition to one or more of the features described herein, or as an alternative, further embodiments of the method may include that the imprecise location of the vehicle is based at least in part on replies from a subset of a plurality of antennae of the vehicle including an amount of time spent to decide which of the plurality of antennae include the subset.

In addition to one or more of the features described herein, or as an alternative, further embodiments of the method may include that generating the imprecise location of the vehicle includes generating a random delay for each of a plurality of antennae of the vehicle.

In addition to one or more of the features described herein, or as an alternative, further embodiments of the method may include that the precise location of the vehicle is more precise than the imprecise location of the user device.

In another embodiment, a vehicle is provided. The vehicle includes a plurality of antennae for wirelessly transmitting data to and wirelessly receiving data from a user device. The vehicle further includes a processing system having a memory including computer readable instructions and a processing device for executing the computer readable instructions. The computer readable instructions control the processing device to perform operations for providing an imprecise location of the vehicle to the user device. The operations include receiving, at the processing system of the vehicle, a handshake request, the handshake request initiated by the user device associated with an operator of the vehicle. The operations further include determining, by the processing system of the vehicle, a precise location of the user device. The operations further include generating, by the processing system of the vehicle, the imprecise location of the vehicle. The operations further include transmitting, via at least one of the plurality of antennae, the imprecise location of the vehicle from the processing system to the user device. The operations further include enabling a virtual key function of the user device based at least in part on the precise location of the user device and the imprecise location of the vehicle.

In addition to one or more of the features described herein, or as an alternative, further embodiments of the vehicle may include that generating the imprecise location of the vehicle includes applying a noise factor.

In addition to one or more of the features described herein, or as an alternative, further embodiments of the vehicle may include that generating the imprecise location of the vehicle includes determining a T_{reply1} value, a T_{round1} value, a T_{round2} value, and a T_{reply2} value, applying the noise factor to each of the T_{reply1} value and the T_{round2} value, and calculating the imprecise location of the vehicle based at least in part on the noise factor applied to each of the T_{reply1} value and the T_{round2} value.

In addition to one or more of the features described herein, or as an alternative, further embodiments of the vehicle may include that applying the noise factor to each of the T_{reply1} value and the T_{round2} value includes subtracting the noise factor from the T_{reply1} value and adding the noise factor to the T_{round2} value.

In addition to one or more of the features described herein, or as an alternative, further embodiments of the vehicle may include that generating the imprecise location of the vehicle includes applying the noise factor to the T_{reply1} value and transmitting a resulting noisy T_{reply1} value to the user device, wherein the user device applies the noisy T_{reply1} value to compute an approximate distance to the vehicle.

In addition to one or more of the features described herein, or as an alternative, further embodiments of the vehicle may include that generating the imprecise location of the vehicle is based at least in part on a time-difference-of-arrival (TDoA) or a phase-difference-of-arrival (PDoA) relative to the plurality of antennae of the vehicle and noise added to results of at least one of the TDoA or PDoA.

In addition to one or more of the features described herein, or as an alternative, further embodiments of the vehicle may include that generating the imprecise location of the vehicle includes generating noisy information about geometric arrangement of the plurality of antennae of the vehicle.

In addition to one or more of the features described herein, or as an alternative, further embodiments of the vehicle may include that the imprecise location of the vehicle is based at least in part on replies from a subset of the plurality of antennae of the vehicle including an amount of time spent to decide which of the plurality of antennae include the subset.

In addition to one or more of the features described herein, or as an alternative, further embodiments of the vehicle may include that generating the imprecise location of the vehicle includes generating a random delay for each of the plurality of antennae of the vehicle.

In another embodiment a computer program product is provided. The computer program product includes a computer readable storage medium having program instructions embodied therewith, the program instructions executable by at least one processor to cause the at least one processor to perform operations. The operations include receiving, at a vehicle, a handshake request, the handshake request initiated by a user device associated with an operator of the vehicle. The operations further include determining, at the vehicle, a precise location of the user device. The operations further include generating, at the vehicle, the precise location of the vehicle. The operations further include transmitting the precise location of the vehicle to the user device. The operations further include masking, at the user device, the precise location of the vehicle to generate an imprecise location of the vehicle, the imprecise location of the vehicle being shared with third-party applications executing on the user device without sharing the precise location of the vehicle with the third-party applications. The operations further include enabling a virtual key function of the user device based at least in part on the precise location of the user device and the imprecise location of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle having a processing system for providing a privacy-enhanced relative location of the vehicle to a user device according to one or more embodiments;

FIG. 2 is a block diagram of the processing system of FIG. 1 for providing a privacy-enhanced relative location of the vehicle of FIG. 1 to the user device of FIG. 1 according to one or more embodiments;

FIG. 3A is a sequence diagram of a single-sided ranging technique;

FIG. 3B is a sequence diagram of a double-sided ranging technique;

FIG. 4 is a flow diagram of a method for providing a privacy-enhanced relative location of the vehicle of FIG. 1 according to one or more embodiments; and

FIG. 5 is a block diagram of a processing system for implementing one or more embodiments described herein.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to providing a privacy-enhanced relative location of a vehicle.

Vehicles may include one or more communication systems for communicating with other devices, other vehicles, and/or the like, including combinations and/or multiples thereof. For example, a vehicle may include a system for communicating with a user device, such as a smartphone, laptop computer, tablet computer, wearable computing device (e.g., smartwatch), and/or the like, including combinations and/or multiples thereof. In such cases, the user device may provide information to the communication system of the vehicle for use by the vehicle and its systems. Similarly, the vehicle may provide information to the user device for use by the user device. One type of information shared between the user device and the communication system of the vehicle is location information (e.g., a location of the user device and/or a location of the vehicle). In one scenario, the user device (e.g., a smartphone) may act as a “virtual key” that replaces a traditional key. A virtual key can be used to lock/unlock the vehicle, start the vehicle (locally or remotely), operate systems of the vehicle (e.g., roll down windows, enable/disable a security alarm, control an infotainment system, navigate/control the vehicle, and/or the like, including combinations and/or multiples thereof). In such cases, the location information of the vehicle and the user device are used for verifying the virtual key and/or enabling some or all of the functionality of the virtual key. For example, the virtual key may be prevented from starting the vehicle if the virtual key in beyond a predefined distance away from the vehicle. Accordingly, virtual keys use location information about the vehicle and/or about the user device.

The location information may be determined, for example, using one-sided localization or two-sided localization. In one-sided localization, one of the devices (e.g., the communication system of the vehicle) precisely locates the other device (e.g., the user device). In two-sided localization, both devices (e.g., the communication system of the vehicle and the user device) precisely locate the other device. While these approaches are suitable for their intended purposes, such approaches fail to provide for approximating the location of one of the devices while precisely locating the other device.

One or more embodiments described herein address these and other shortcomings by providing a privacy-sensitive localization approach that precisely locates one device while approximating the location of the other device. Such an approach may be useful in the case of virtual keys where it is desirable for the vehicle to precisely locate the user device while allowing the user device to only approximate the location of the vehicle (e.g., the communication system of the vehicle) without learning its precise location. As used herein, approximating the location of a vehicle (e.g., the communication system of the vehicle) involves determining a relative location of the vehicle that does not precisely define the location of the vehicle.

Embodiments described herein provide multiple techniques for determining privacy-enhanced relative location of a vehicle. Oner or more embodiments use a combination of techniques, such as adding noise to ranging data, the geometric configuration information sent from one device to another, introducing delays in sending ranging information, and/or the like, including combinations and/or multiples thereof. These techniques are described in more detail herein.

It should be appreciated that the functioning of a vehicle implementing one or more of the embodiments described herein is improved. For example, by providing an imprecise location of the vehicle, security of the vehicle is improved by preventing a user device from making the precise location of the vehicle available to third parties (e.g., via a malicious third-party application executing on the user device). This reduces or eliminates potential cybersecurity threats and/or malicious attacks on the vehicle by masking the vehicle's precise location. Other benefits and advantages are also apparent to persons having ordinary skill in the art.

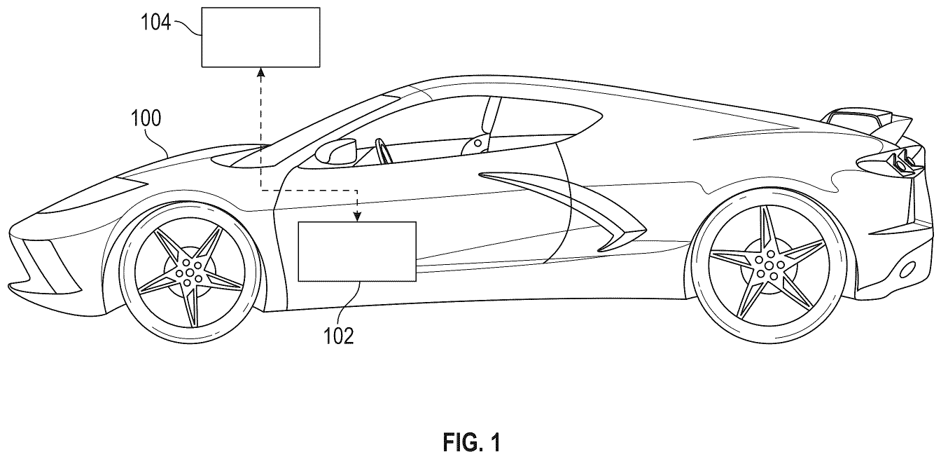

FIG. 1 is an illustration of a vehicle 100 having a processing system 102 for providing a privacy-enhanced relative location of the vehicle to a user device 104 according to one or more embodiments.

The vehicle 100 can be a car, a truck, a van, a bus, a motorcycle, a boat, or any other type of automobile. According to an embodiment, the vehicle 100 includes an internal combustion engine fueled by gasoline, diesel, or the like. According to another embodiment, the vehicle 100 is a hybrid electric vehicle partially or wholly powered by electrical power. According to another embodiment, the vehicle 100 is an electric vehicle powered by electrical power. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

According to one or more embodiments, the vehicle 100 includes the processing system 102. The processing system 102 is an example of a “communication system” as described herein and can communicate directly or indirectly with the user device 104. The processing system 102 can use any suitable technique for communicating with the user device 104, such as Bluetooth, WiFi, infrared, radio frequency (RF), and/or the like, including combinations and/or multiples thereof.

The user device 104 can be any suitable device for communicating with the processing system 102. For example, the user device 104 can be a smartphone, laptop computer, tablet computer, wearable computing device (e.g., smartwatch), and/or the like, including combinations and/or multiples thereof. According to one or more embodiments, the user device 104 can execute a software application that provides virtual key functionality for the vehicle.

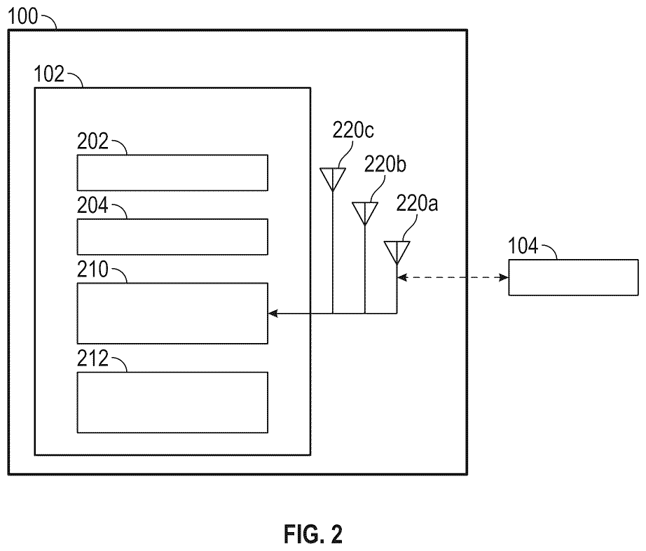

Further features of the processing system 102 are now described with reference to FIG. 2

Particularly, FIG. 2 is a block diagram of the processing system 102 of FIG. 1 for providing a privacy-enhanced relative location of the vehicle of FIG. 1 to the user device of FIG. 1 according to one or more embodiments. The processing system 102 includes a processing device 202, a memory 204, a communication engine 210, and a localization engine 212. It should be appreciated that the processing system 102 can be any device suitable for communicating with the user device 104 and/or for performing one or more of the localization techniques described herein. For example, the processing system 102 can be a device implemented in or otherwise associated with the vehicle 100. As another example, the processing system 102 can be a smartphone, tablet computer, laptop computer, desktop computer, wearable computing device, and/or the like, including combinations and/or multiples thereof.

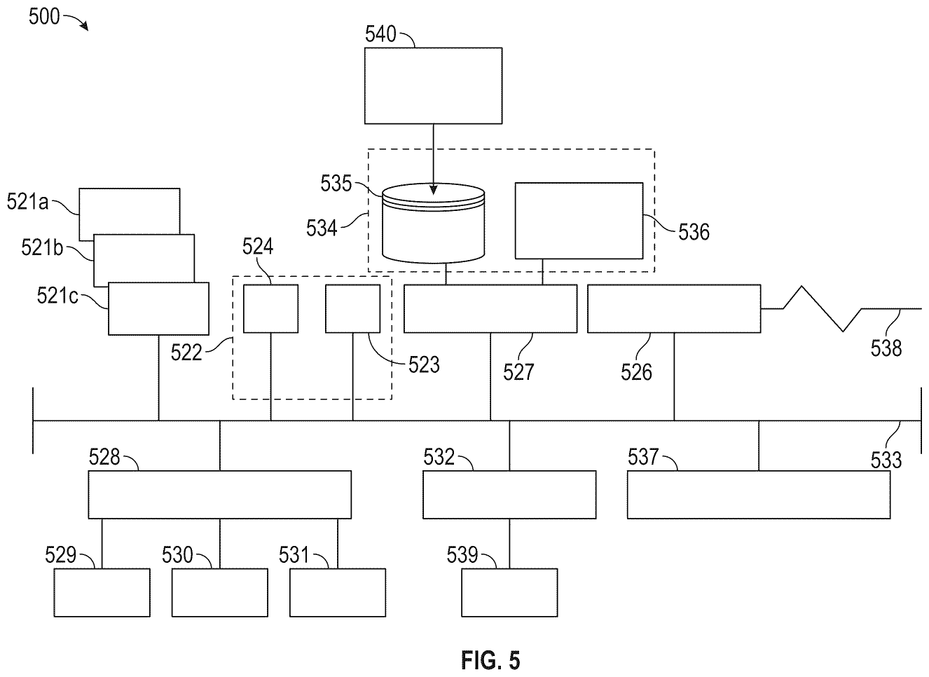

The processing device 202 is any suitable processing circuitry for processing data (e.g., localization data and/or communication data) and/or instructions. The processing device 202 is an example of one or more of the processing devices 521 of FIG. 5, as described in more detail herein.

The memory 204 is any suitable device for storing data and/or instructions. The memory 204 is an example of one or more of the system memory 522, the random access memory 523, and/or the read-only memory 524 of FIG. 5, as described in more detail herein.

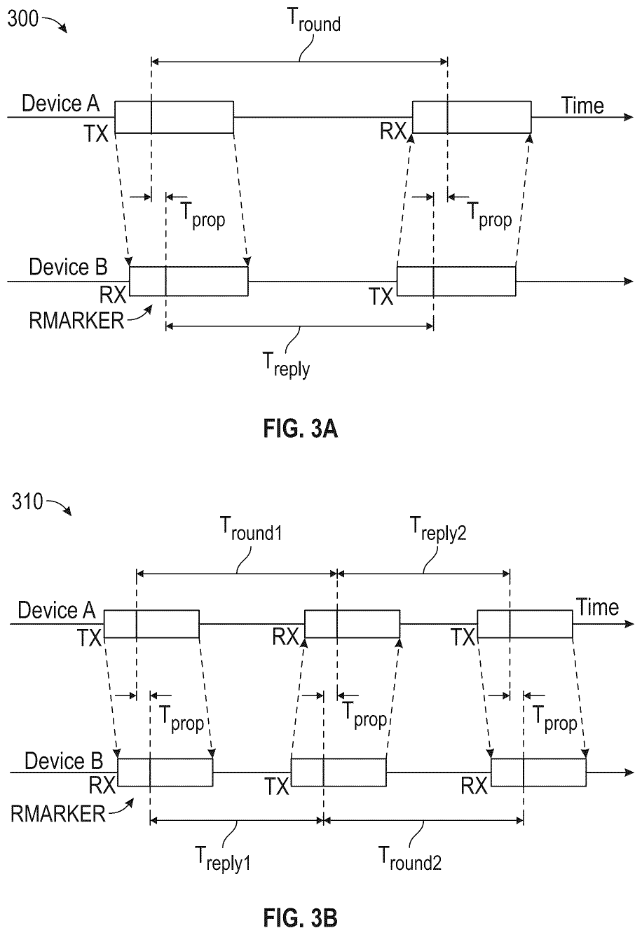

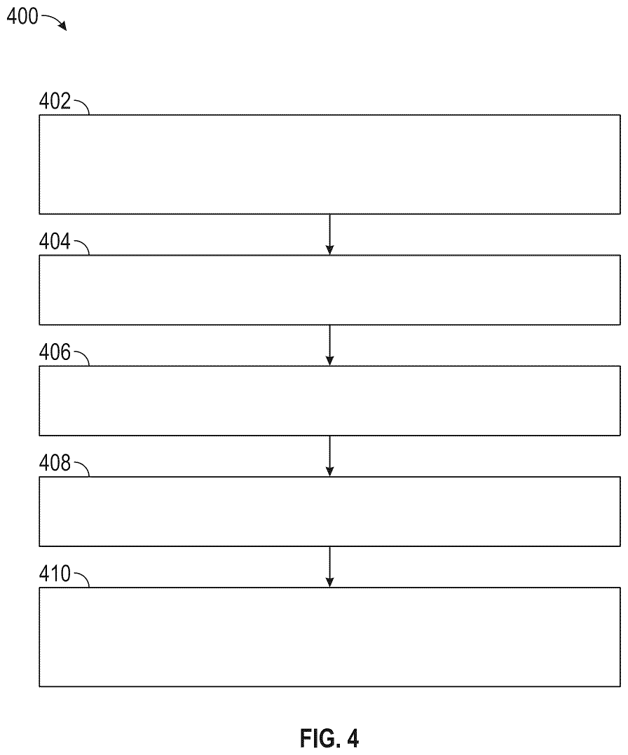

The communication engine 210 facilitates communication between the processing system 102 (and/or other devices/systems of the vehicle) and the user device 104. For example, the communication engine 210 utilizes one or more antennae 220a, 220b, 220c (collectively “antennae 220”) to wirelessly transmit data to and receive data from the user device 104. The localization engine 212 provides for determining a precise location of the user device 104 and generates an imprecise location of the vehicle 100, which can be transmitted or otherwise provided to the user device 104. Features and functionality of the communication engine 210 and the localization engine 212 are now described in more detail with reference to FIGS. 3A-4.

Turning now to FIGS. 3A and 3B, further details of the communication engine 210 and the localization engine 212 are described. The localization engine 212 can perform localization (or “ranging”) techniques to determine a distance between the vehicle 100 and the user device 104. For example, the localization engine 212 can perform single-sided ranging or double-sided ranging. Single-side ranging and double-side ranging are techniques used in distance measurement, often utilized in navigation, surveying, and communication systems. FIG. 3A is a sequence diagram 300 of a single-sided ranging technique. Single-side ranging involves measuring the distance between two points (e.g., one of the antennae 220 of the vehicle and the user device 104) by sending a signal from one point (transmitter) to another point (receiver) and then calculating the distance between those points based on the time it takes for the signal to travel. FIG. 3B is a sequence diagram 310 of a double-sided ranging technique. Double-side ranging (or two-way ranging) improves accuracy by measuring the time it takes for a signal to travel from the transmitter to the receiver and back again. Single-sided and double sided ranging are now described in more detail.

An initiator (e.g., the user device 104) (labeled “Device A” in FIGS. 3A and 3B) has at least one antenna (also referred to as a “ranging anchor” or “anchor”). A responder (e.g., the processing system 102 of the vehicle 100) has multiple antennae/ranging anchors (e.g., the antennae 220). FIGS. 3A and 3B show an exchange between the Device A and one anchor of Device B. Device A (e.g., the user device 104) transmits (Tx) a first polling message P1 to Device B (e.g., the processing system 102). Each anchor (e.g., the antennae 220) on Device B (e.g., the processing system 102) receives (Rx) and processes the first polling message P1 and responds (e.g., transmits (Tx)) with a response M2. Device A processes responses from the multiple anchors of Device B, where applicable, and sends (e.g., transmits (Tx)) a reply message M3 back to Device B. For each exchange between Device A and Device B, the following ranging values exist: a T_{reply2} value (at Device A), a T_{round1} value (at Device A), a T_{round2} value (at Device B), and a T_{reply1} value (at Device B). According to one or more embodiments, the localization engine 212 calculates the T_{round2} value and the T_{reply1} value. Device A sends its ranging information to Device B, which allows Device B to determine a distance of Device A relative to the anchors (e.g., the antennae 220) of Device B. The localization engine 212 performs trilateration to determine a location of Device A relative to Device B.

For either single-sided ranging or double-sided ranging, the localization engine 212 computes a propagation time, which is used to determine the distance between Device A (e.g., the user device 104) and one or more of the antennae 220 of Device B (e.g., the processing system 102).

For single-sided ranging, the propagation time is determined using the following equation:

$${T}_{prop} = ( {T}_{round} - {T}_{reply} ) / 2.$$

For double-sided ranging, the propagation time is determined using the following equation:

$${T}_{prop} = \frac{{T}_{round 1} \times {T}_{round 2} - {T}_{reply 1} \times {T}_{reply 2}}{{T}_{round 1} \times {T}_{round 2} + {T}_{reply 1} \times {T}_{reply 2}} .$$

Once the localization engine 212 computes the propagation time, the localization engine 212 can use the propagation time to determine the distance between Device A (e.g., the user device 104) and one or more of the antennae 220 of Device B (e.g., the processing system 102).

The various components, modules, engines, etc. described regarding FIG. 2 (e.g., the communication engine 210 and/or the localization engine 212) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 202 for executing those instructions. Thus, a system memory (e.g., memory 204) can store program instructions that, when executed by the processing device 202, implement the engines described herein. Other engines can also be utilized to include other features and functionality described in other examples herein.

Further aspects and features of the communication engine 210 and/or the localization engine 212 are described herein with respect to FIGS. 3A-4.

FIG. 4 is a flow diagram of a method 400 for providing a privacy-enhanced relative location of the vehicle 100 according to one or more embodiments. The method 400 can be implemented using any suitable system or device. For example, the method 400 can be implemented using the processing system 102 of FIGS. 1 and 2, by the processing system 500 of FIG. 5, and/or the like, including combinations and/or multiples thereof. The method 400 is now described with reference to FIGS. 1 and 2 but is not so limited.

At block 402, the processing system 102 of the vehicle 100 receives a handshake request from the user device 104. That is, the handshake request is initiated by the user device 104, such as by an operator of the vehicle 100 initializing a virtual key application on the user device 104.

At block 404, the processing system 102 of the vehicle 100 (e.g., using the localization engine 212) determines a precise location of the user device 104. The precise location of the user device 104 is determined, for example, using single-sided or double-sided ranging as described herein.

At block 406, the processing system 102 of the vehicle 100 (e.g., using the localization engine 212) generates the imprecise location of the vehicle 100. The precise location of the vehicle 100 is more precise than the imprecise location of the vehicle 100. Described herein are multiple techniques for generating the imprecise location of the vehicle 100.

According to one or more embodiments, generating the imprecise location of the vehicle 100 includes applying noise to cause the location of the vehicle 100 to be imprecise. Applying noise can be done as follows, for example. First, a T_{reply1} value, a T_{round1} value, a T_{round2} value, and a T_{reply2} value are determined. Then, a noise factor is applied to each of the T_{reply1} value and the T_{round2} value. According to one or more embodiments, applying the noise factor to each of the T_{reply1} value and the T_{round2} value includes subtracting the noise factor from the T_{reply1} value and adding the noise factor to the T_{round2} value as follows:

$${T}_{Reply 1} *= {T}_{Reply 1} - δ , {T}_{Round 2} *= {T}_{Round 2} + δ ,$$

where δ is the noise factor. Finally, the imprecise location of the vehicle 100 is calculated based at least in part on the noise factor applied to each of the T_{reply1} value and the T_{round2} value.

According to one or more embodiments, noise can be added by applying the noise factor to the T_{reply1} value and then transmitting the T_{reply1} value to the user device 104. The user device 104 verifies the received value (e.g., a T_{reply1} value with noise added) and then uses it to compute an approximate (or imprecise) distance to the vehicle 100.

According to one or more embodiments, generating the imprecise location of the vehicle is based at least in part on a time-difference-of-arrival (TDoA) or a phase-difference-of-arrival (PDoA) relative to a plurality of antennae (e.g., the antennae 220) of the vehicle 100. TDoA and PDoA can be used to perform localization to determine a position of the antennae 220 relative to the user device 104 based on measuring differences in signal properties at multiple receivers (e.g., multiples of the antennae 220). TDoA determines the position of a signal source by measuring the difference in arrival times of the signal at multiple of the antennae 220 (e.g., the antenna 220a and the antenna 220b), which are spatially separated. To perform TDoA-based localization, the user device 104 emits a signal, which is received at multiple of the antennae 220 (e.g., the antenna 220a and the antenna 220b). Due to their spatial separation, the multiple of the antennae 220 receive the signal at sightly different times. The difference in arrival times of the signal at the multiple of the antennae 220 is measured and, using the known positions of the antennae 220 and the measured time differences, the position of the source signal can be calculated (e.g., solving hyperbolic equations derived from the time differences). PDoA determines the position of a signal source by measuring the difference in the phase of the signal at multiple receivers (e.g., multiples of the antennae 220). To perform PDoA, the user device 104 emits a signal, which is received at multiple of the antennae 220 (e.g., the antenna 220a and the antenna 220b). The phase difference between the signals received at the multiple of the antennae 220 is measured. Using the known positions of the multiple of the antennae 220 and the measured phase differences, the position of the source signal can be calculated (e.g., solving equations that relate the phase differences to the geometry of the multiple of the antennae 220). To generate the imprecise location, noise can be added to the processes for either TDoA or PDoA such that the resulting location is imprecise.

According to one or more embodiments, generating the imprecise location of the vehicle 100 includes generating noisy information about geometric arrangement of a plurality of antennae of the vehicle. That is noise is added to geometric information (e.g., position) of the antennae 220. According to one or more embodiments, noisy information about geometric configuration of the antennae 220 is sent to the user device 104 rather than changing information about the time.

According to one or more embodiments, the imprecise location of the vehicle 100 is based at least in part on replies from a subset of the antennae 220 including an amount of time spent to decide which of the plurality of antennae to include in the subset. For example, each of the antennae 220 are left on for reception to avoid degrading localization on the vehicle side. However, only a subset of the antennae 220 is used to reply to the user device 104. For example, two or three antennae (of the antennae 220) with the least favorable geometric configuration respond to the user device 104. To locate the vehicle 100, the user device 104 has to find a way to place the vertices of a pre-defined triangle (segment), corresponding to the antennae 220 that replied, on multiple concentric circles, which may return several positions, thus preventing the user device 104 from determining the precise location of the vehicle 100. The antennae 220 that are used to reply include, in their final data message to the user device 104, an amount of time that is spent deciding which antennae 220 to respond, which is added to the T_{reply1} value. In some embodiments, an additional noise factor can be added to the time (e.g., the T_{reply1} value) to further cause the location of the vehicle 100 to be imprecise.

According to one or more embodiments, generating the imprecise location of the vehicle 100 includes generating a random delay for each of the antennae 220 of the vehicle 100. In such case, each of the antennae 220 remain active but each can add a random delay (e.g., by skipping their timeslots by a certain amount of time) and sending a correcting factor to the user device in a final data message. In some embodiments, noise can be added to the correction factors as described herein for one or more of the antennae 220.

At block 408, the processing system 102 of the vehicle 100 (e.g., using the localization engine 212) transmits the imprecise location of the vehicle 100 from the processing system 102 to the user device 104.

At block 410, a virtual key function of the user device 104 is enabled based at least in part on the precise location of the user device 104 and the imprecise location of the vehicle 100. The user device 104 can then interact with the vehicle 100 using the virtual key function without having the precise location of the vehicle 100. This improves security of the vehicle 100 by preventing the user device 104 from making the precise location of the vehicle 100 available to third parties (e.g., via a malicious third-party application executing on the user device 104).

According to one or more embodiments, rather than the user device 104 generating the imprecise location of the vehicle 100 using noisy information sent by the vehicle 100, the vehicle 100 can generate its own imprecise location and send it to the user device 104. In another embodiment, the user device 104 can mask the precise location of the vehicle 100 to generate an imprecise location of the vehicle 100. The imprecise location of the vehicle 100 is what is shared with third-party applications executing on the user device 104 without sharing the precise location of the vehicle 100 with those third-party applications. Again, this improves security of the vehicle 100 by preventing the user device 104 from making the precise location of the vehicle 100 available to third parties (e.g., via a malicious third-party application executing on the user device 104).

Additional processes also may be included, and it should be understood that the processes depicted in FIG. 4 represent illustrations, and that other processes may be added, or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processing device 202 of FIG. 2, the processor(s) 521 of FIG. 5, and/or the like, including combinations and/or multiples thereof) of a computing system (e.g., the processing system 102 of FIGS. 1 and 2, the processing system 500 of FIG. 5, and/or the like, including combinations and/or multiples thereof), cause the processor to perform the processes described herein.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node of a cloud computing environment. In examples, processing system 500 has one or more central processing units (referred to also as “processors” or “processing resources” or “processing devices”) 521a, 521b, 521c, etc. (collectively or generically referred to as processor(s) 521 and/or as processing device(s)). In aspects of the present disclosure, each processor 521 can include a reduced instruction set computer (RISC) microprocessor. Processors 521 are coupled to a system memory 522 and/or various other components via a system bus 533. The system memory 522 can include one or more temporary and/or persistent memory devices, such as a random access memory (RAM) 523, a read-only memory (ROM) 524, and/or the like, including combinations and/or multiples thereof. The system bus 533 may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 535 and/or a storage device 536 or any other similar component. I/O adapter 527, hard disk 535, and storage device 536 are collectively referred to herein as mass storage 534. Operating system 540 for execution on processing system 500 may be stored in mass storage 534. The network adapter 526 interconnects system bus 533 with an outside network 538 enabling processing system 500 to communicate with other such systems.

A display (e.g., a display monitor) 539 is connected to system bus 533 by display adapter 532, which may include a graphics adapter to improve the performance of graphics intensive applications and a video controller. In one aspect of the present disclosure, adapters 526, 527, and/or 532 may be connected to one or more I/O buses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 may be interconnected to system bus 533 via user interface adapter 528, which may include, for example, a Super I/O chip integrating multiple device adapters into a single integrated circuit.

In some aspects of the present disclosure, processing system 500 includes a graphics processing unit (GPU) 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing, and has a highly parallel structure that makes it more effective than general-purpose CPUs for algorithms where processing of large blocks of data is done in parallel.

Thus, as configured herein, processing system 500 includes processing capability in the form of processors 521, storage capability including the system memory 522 and mass storage 534, input means such as keyboard 529 and mouse 530, and output capability including speaker 531 and display 539. In some aspects of the present disclosure, a portion of system memory 522 and mass storage 534 collectively store the operating system 540 to coordinate the functions of the various components shown in processing system 500.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for providing an imprecise location of a vehicle to a user device, the method comprising:
receiving, at a processing system of the vehicle, a handshake request, the handshake request initiated by the user device associated with an operator of the vehicle;
determining, by the processing system of the vehicle, a precise location of the user device;
generating, by the processing system of the vehicle, the imprecise location of the vehicle;
transmitting the imprecise location of the vehicle from the processing system to the user device; and
enabling a virtual key function of the user device based at least in part on the precise location of the user device and the imprecise location of the vehicle.

2. The computer-implemented method of claim 1, wherein generating the imprecise location of the vehicle comprises applying a noise factor.

3. The computer-implemented method of claim 2, wherein generating the imprecise location of the vehicle comprises:
determining a T_{reply1} value, a T_{round1} value, a T_{round2} value, and a T_{reply2} value;
applying the noise factor to each of the T_{reply1} value and the T_{round2} value; and
calculating the imprecise location of the vehicle based at least in part on the noise factor applied to each of the T_{reply1} value and the T_{round2} value.

4. The computer-implemented method of claim 3, wherein applying the noise factor to each of the T_{reply1} value and the T_{round2} value comprises subtracting the noise factor from the T_{reply1} value and adding the noise factor to the T_{round2} value.

5. The computer-implemented method of claim 2, wherein generating the imprecise location of the vehicle comprises applying the noise factor to the T_{reply1} value and transmitting a resulting noisy T_{reply1} value to the user device, wherein the user device applies the noisy T_{reply1} value to compute an approximate distance to the vehicle.

6. The computer-implemented method of claim 1, wherein generating the imprecise location of the vehicle is based at least in part on a time-difference-of-arrival (TDoA) or a phase-difference-of-arrival (PDoA) relative to a plurality of antennae of the vehicle and noise added to results of at least one of the TDoA or PDoA.

7. The computer-implemented method of claim 1, wherein generating the imprecise location of the vehicle comprises generating noisy information about geometric arrangement of a plurality of antennae of the vehicle.

8. The computer-implemented method of claim 1, wherein the imprecise location of the vehicle is based at least in part on replies from a subset of a plurality of antennae of the vehicle including an amount of time spent to decide which of the plurality of antennae comprise the subset.

9. The computer-implemented method of claim 1, wherein generating the imprecise location of the vehicle comprises generating a random delay for each of a plurality of antennae of the vehicle.

10. The computer-implemented method of claim 1, wherein the precise location of the vehicle is more precise than the imprecise location of the user device.

11. A vehicle comprising:
a plurality of antennae for wirelessly transmitting data to and wirelessly receiving data from a user device; and
a processing system, the processing system comprising:
a memory comprising computer readable instructions; and
a processing device for executing the computer readable instructions, the computer readable instructions controlling the processing device to perform operations for providing an imprecise location of the vehicle to the user device, the operations comprising:
receiving, at the processing system of the vehicle, a handshake request, the handshake request initiated by the user device associated with an operator of the vehicle;
determining, by the processing system of the vehicle, a precise location of the user device;
generating, by the processing system of the vehicle, the imprecise location of the vehicle;
transmitting, via at least one of the plurality of antennae, the imprecise location of the vehicle from the processing system to the user device; and
enabling a virtual key function of the user device based at least in part on the precise location of the user device and the imprecise location of the vehicle.

12. The vehicle of claim 11, wherein generating the imprecise location of the vehicle comprises applying a noise factor.

13. The vehicle of claim 12, wherein generating the imprecise location of the vehicle comprises:
determining a T_{reply1} value, a T_{round1} value, a T_{round2} value, and a T_{reply2} value;
applying the noise factor to each of the T_{reply1} value and the T_{round2} value; and
calculating the imprecise location of the vehicle based at least in part on the noise factor applied to each of the T_{reply1} value and the T_{round2} value.

14. The vehicle of claim 13, wherein applying the noise factor to each of the T_{reply1} value and the T_{round2} value comprises subtracting the noise factor from the T_{reply1} value and adding the noise factor to the T_{round2} value.

15. The vehicle of claim 12, wherein generating the imprecise location of the vehicle comprises applying the noise factor to the T_{reply1} value and transmitting a resulting noisy T_{reply1} value to the user device, wherein the user device applies the noisy T_{reply1} value to compute an approximate distance to the vehicle.

16. The vehicle of claim 11, wherein generating the imprecise location of the vehicle is based at least in part on a time-difference-of-arrival (TDoA) or a phase-difference-of-arrival (PDoA) relative to the plurality of antennae of the vehicle and noise added to results of at least one of the TDoA or PDoA.

17. The vehicle of claim 11, wherein generating the imprecise location of the vehicle comprises generating noisy information about geometric arrangement of the plurality of antennae of the vehicle.

18. The vehicle of claim 11, wherein the imprecise location of the vehicle is based at least in part on replies from a subset of the plurality of antennae of the vehicle including an amount of time spent to decide which of the plurality of antennae comprise the subset.

19. The vehicle of claim 11, wherein generating the imprecise location of the vehicle comprises generating a random delay for each of the plurality of antennae of the vehicle.

20. A computer program product comprising a computer readable storage medium having program instructions embodied therewith, the program instructions executable by at least one processor to cause the at least one processor to perform operations comprising:
receiving, at a vehicle, a handshake request, the handshake request initiated by a user device associated with an operator of the vehicle;
determining, at the vehicle, a precise location of the user device;
generating, at the vehicle, the precise location of the vehicle;
transmitting the precise location of the vehicle to the user device;
masking, at the user device, the precise location of the vehicle to generate an imprecise location of the vehicle, the imprecise location of the vehicle being shared with third-party applications executing on the user device without sharing the precise location of the vehicle with the third-party applications; and
enabling a virtual key function of the user device based at least in part on the precise location of the user device and the imprecise location of the vehicle.
